(19) United States
(12) Patent Application Publication
(10) Pub. No.: US 2014/0067612 A1
(43) Pub. Date: Mar. 6, 2014

(54) FACILITATING INTRODUCTIONS BETWEEN BUYERS AND AUTOMOBILE DEALERS

(71) Applicant: Lotlinx, Inc., San Francisco, CA (US)

(72) Inventors: Len SHORT, San Francisco, CA (US); Mark SCHELDE, San Francisco, CA (US); Tim PRATT, San Francisco, CA (US); Robert VUCIC, San Francisco, CA (US)

(73) Assignee: LOTLINX, INC., San Francisco, CA (US)

(21) Appl. No.: 14/010,364

(22) Filed: Aug. 26, 2013

Related U.S. Application Data
(60) Provisional application No. 61/696,028, filed on Aug. 31, 2012.

(51) Int. Cl. G06Q 30/06

(52) U.S. Cl. CPC G06Q 30/0625
USPC 705/26.62

(57) ABSTRACT

System and processes for facilitating introductions between consumers and dealers are provided. In one example method, a vehicle database storing information for vehicles being sold by multiple dealers may be searched using vehicle search criteria provided by a consumer. A list of available vehicles may be returned to the consumer and, in response to a selection by the consumer, the consumer may be deep linked to a webpage of a dealer's website. The number of consumers that are deep linked to a particular website may be tracked, and the owner of the website may be charged accordingly.

### CROSS-REFERENCE TO RELATED APPLICATIONS

This application claims priority to U.S. Provisional Application No. 61/696,028 filed with the U.S. Patent and Trademark Office on Aug. 31, 2012, the entire contents of which are hereby incorporated by reference.

### BACKGROUND

1. Field

This disclosure relates generally to online automobile transactions and, more particularly, to facilitating introductions between online consumers and automobile dealers.

2. Related Art

There are tens of thousands of branded and independent car dealerships in the U.S. As a result, a great deal of time and money is spent to advertise available automobile inventory to attract potential buyers. For example, conventional advertisement methods include direct marketing whereby dealers place ads on the radio, T.V., newspaper, and the like. However, these methods may be very expensive and untargeted, resulting in a low rate of return on investment. Another conventional advertising method is known as “lead acquisition,” whereby consumers may anonymously search for a vehicle and compare it to other available vehicles. When the consumer finds a suitable vehicle, the system may record the consumer's contact information and may sell this information as “leads” to the dealer that posted the vehicle listing. The system may also sell the consumer's contact information to other dealers offering similar vehicles. These dealers may then directly contact the potential buyer. While this conventional method may facilitate transactions between buyers and sellers, it is an extremely inefficient method that generates frustration for both the buyer and the seller. For instance, many consumers feel uncomfortable providing their contact information to any dealer willing to pay the requisite fee. Additionally, on average, less than 5% of leads sold result in a sale of a vehicle, resulting in a loss of time and money for the dealer.

Thus, what is desired are processes and systems that allow a consumer to search for a suitable vehicle having desired properties and that efficiently connect the consumer with the dealer of the vehicle to engage in a transaction for that vehicle between the consumer and a dealer of the vehicle.

### SUMMARY

Methods for facilitating introductions between a consumer and a dealer of an automobile are disclosed. In one example, a method includes providing a database comprising information for a plurality of automobiles being sold by a plurality of automobile dealers; and in response a consumer selecting an automobile of the plurality of automobiles from a search website, deep linking the consumer to a webpage of a dealer's website, wherein the webpage comprises information specific to the selected automobile, and wherein the search website is separate from the dealer's website.

In some examples, the method may further include, prior to the consumer selecting the automobile: receiving, from the consumer, automobile search criteria; searching the database using the search criteria; and transmitting a ranked list of automobiles based on the searching of the database, wherein the consumer selects the automobile from the ranked list.

In some examples, deep linking the consumer to the webpage of the dealer's website may include transmitting, to the consumer, a deep link URL for the webpage in the ranked list. In other examples, the search criteria may include one or more of vehicle identification number (VIN), make, model, color, price, or location.

In some examples, the method may further include populating the database using a crawler. In other examples, the method may further include populating the database using information received from a dealer or a third party entity.

In some examples, the method may further include tracking a number of times that consumers are deep linked to the dealer's website; and charging a fee to an owner of the dealer's website based on the tracked number of times that consumers are deep linked to the dealer's website.

In some examples, the method may further include receiving, from a server of the search website, a unique identifier for the selected automobile. In some examples, deep linking the consumer to the webpage of the dealer's website may include transmitting a deep link URL for the webpage to the server of the search website. In other examples, deep linking the consumer to the webpage of the dealer's website may include transmitting a deep link URL for the webpage to the consumer.

Apparatus and computer-readable storage media for performing the methods are also disclosed.

### BRIEF DESCRIPTION OF THE DRAWINGS

FIG. 1A illustrates an exemplary automotive market place system for facilitating introductions between consumers and dealers according to various embodiments.

FIG. 1B illustrates an exemplary server architecture that may be used with the system of FIG. 1A, according to various embodiments.

FIG. 2A illustrates an exemplary interface for searching for vehicles stored within the system of FIG. 1A.

FIG. 2B illustrates an exemplary interface for displaying search results in response to a search query entered into the interface of FIG. 2A.

FIG. 3 illustrates an exemplary interface for displaying detailed information about a vehicle, according to various embodiments.

FIG. 4 illustrates an exemplary process for facilitating introductions between users and dealers, according to various embodiments.

FIG. 5 illustrates an exemplary computing system that may be employed to implement processing functionality for various aspects of the present disclosure.

### DETAILED DESCRIPTION

In the following description of preferred embodiments, reference is made to the accompanying drawings which form a part hereof, and in which it is shown by way of illustration specific embodiments in which the invention may be practiced. It is to be understood that other embodiments may be used and structural changes may be made without departing from the scope of the invention.

System and processes for facilitating introductions between consumers and dealers are provided. In one example method, a vehicle database storing information for vehicles being sold by multiple dealers may be searched using vehicle search criteria provided by a consumer. A list of available vehicles may be returned to the consumer and, in response to a selection by the consumer, the consumer may be deep linked to a webpage of a dealer's website. The number of consumers that are deep linked to a particular website may be tracked, and the owner of the website may be charged accordingly.

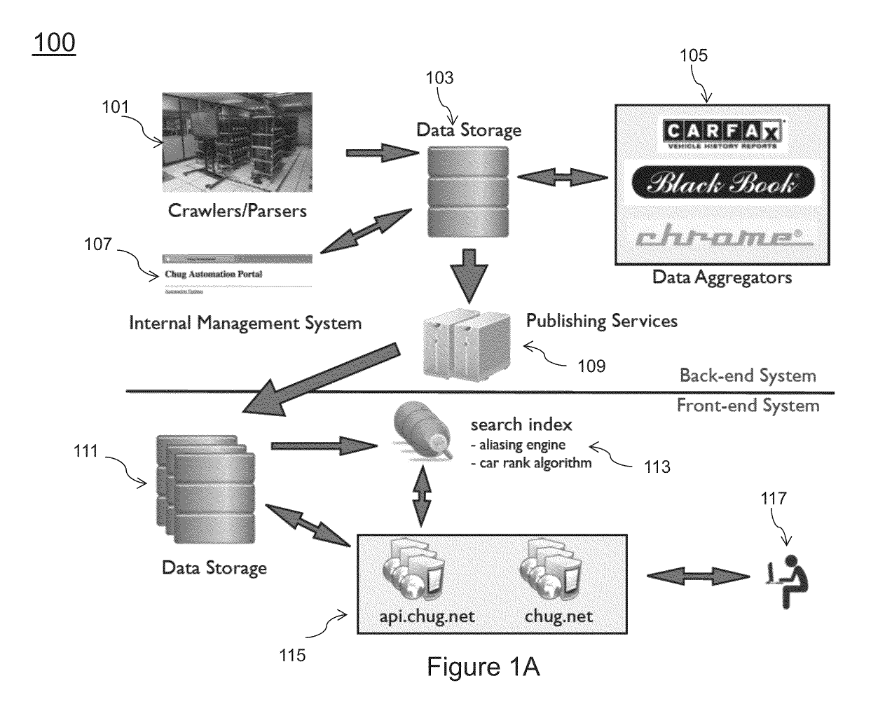

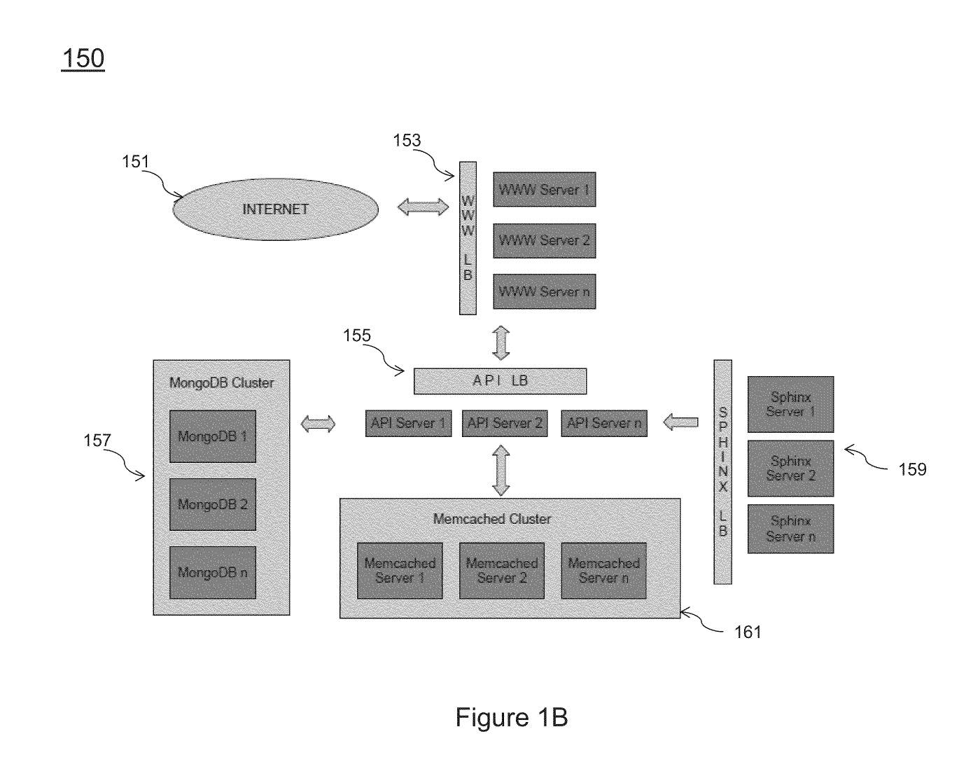

FIG. 1A illustrates an exemplary automotive market place system 100 for facilitating introductions between consumers and dealers according to various embodiments. System 100 may include data storage 103 for storing a listing of vehicles and associated vehicle information, such as vehicle identification number (VIN), make, model, color, price, location, and the like. In some examples, the vehicle data may be stored in data storage 103 according to a unique identifier, such as their VIN.

System 100 may further include crawler/parser 101 coupled to data storage 103. Crawler/parser 101 may be used to crawl the Internet to identify available vehicles posted on various participating websites. In particular, websites of dealers that have agreed to pay a fee for inclusion within data storage 103 may be periodically or intermittently crawled using crawler/parser 101 to provide up to date information regarding the dealer's stock of vehicles. Crawler/parser 101 may then parse the crawled data to extract vehicle information, such as VIN, price, mileage, images, and the like. Crawler/parser 101 may also normalize listing option information and may map to Chrome option language. An example crawler/parser 101 that may be used is described in U.S. patent application Ser. No. 12/784,401, entitled “AUTOMOTIVE MARKET PLACE SYSTEM,” which is incorporated by reference herein in its entirety as if put forth in full below. The output (e.g., vehicle information, such as VIN, price, mileage, images, and the like) may be stored in data storage 103.

System 100 may further include data aggregators 105 coupled to data storage 103. Data aggregators 105 may aggregate and normalize vehicle data for data storage 103. Data storage 103 may also be coupled to internal management system 107, which allows a system user to manage the contents of data storage 103. Data storage 103 may further be coupled to publishing services 109. Publishing services 109 may include one or more servers for providing vehicle information stored in data storage 103. The above listed elements may make up the back-end portion of system 100.

System 100 may further include a front-end data storage 111 coupled to receive information from publishing services 109. Data storage 111 may be coupled to search index 113, which may include an aliasing engine and a car rank algorithm. An example search index 113 having an aliasing engine and car rank algorithm is described in U.S. patent application Ser. No. 12/784,401, entitled “AUTOMOTIVE MARKET PLACE SYSTEM.” Search index 113 may be used to provide a ranked list of vehicles stored in data storage 111 and/or data storage 103 to a user 117 via an API 115 based on search criteria provided by the user 117. In some examples, the owner or operator of the back-end portion of system 100 may be the same as the owner or operator of the front-end system. In other examples, one entity may own or operate the back-end system, while a partner entity or website, such as an automobile search website, may own or operate the front-end system.

FIG. 1B illustrates an exemplary server architecture 150 that may be employed by system 100. Architecture 150 may include web servers 153 coupling the API LB 155 of system 100 to the Internet 151. API LB 155 may include one or more API servers for coupling API LB 155 to a data storage system (e.g., MongoDB cluster 157), a caching service (e.g., Memcached Cluster 161), and full-text search index (e.g., Sphinx search index 159). In the illustrated example, MongoDB cluster 157 includes a highly scalable and performant non-relational data storage system, Sphinx search index 159 includes a highly scalable and performant full text search index, and Memcached cluster 161 includes cached database results that may be accessed by API LB 155. Using architecture 150, system 100 may be scaled to support a large number of partner websites and dealers. While specific examples are provided above for the data storage system, caching service, and full-text search index of server architecture 150, it should be appreciated that any other systems, services, or search indexes may be used.

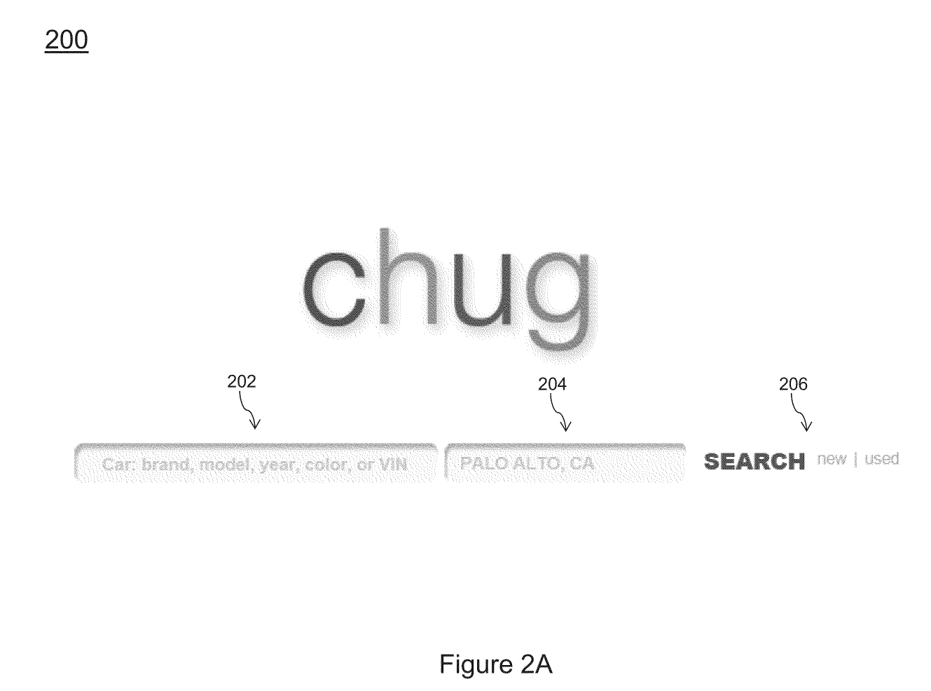

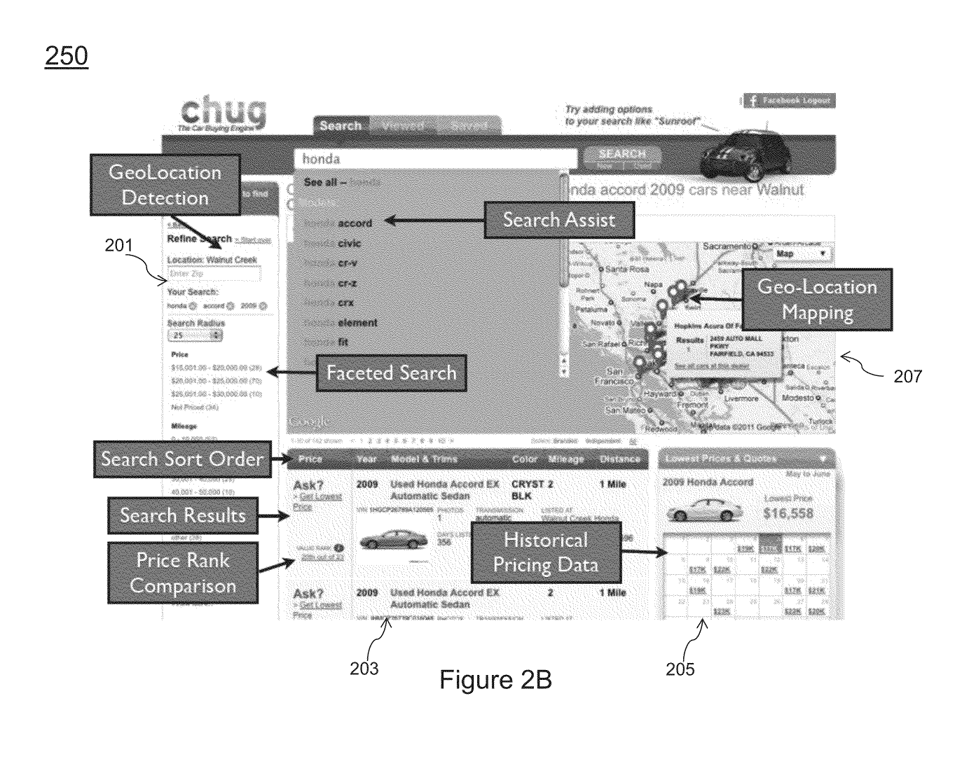

FIG. 2A illustrates an exemplary interface 200 of a search website that may be presented to user 117 to search vehicles stored within system 100. In some examples, interface 200 may include search fields 202 and 204 to allow the user to enter keywords, such as vehicle brand, model, year, color, VIN, and the like, as well as a location of the vehicle. Interface 200 may further include search button 206 to allow the user to instruct the system to search new or used cars. The search criteria entered in search portion 201 may be provided to search index 113 of system 100, which in turn may search database 111 for vehicles matching the user's request.

FIG. 2B illustrates an exemplary interface 250 of a search website that may be presented to user 117 in response to a search query entered in interface 200. In some examples, interface 250 may include search portion 201 that allows a user to refine their search request using refining search options, such as keywords, location, brand, price, and the like. The refining search criteria entered in search portion 201 may also be provided to search index 113 of system 100. As refining search criteria is entered, the search results displayed in interface 250 may be modified accordingly. While specific examples are listed, it should be appreciated that any other search options known to those of ordinary skill in the art may be provided to the user.

Interface 250 may further include results portion 203 containing a ranked list of vehicles that match the user's search criteria entered in interface 200 and/or refining search criteria entered in search portion 201. Results portion 203 may be populated with vehicle information that is obtained from data storage 103 or 111, ranked using search index 113, and returned to the user via API 115. Interface 250 may further include temporal results portion 205 that shows historical pricing data associated with one or more vehicles listed in results portion 203. Historical pricing data may be provided using time-stamped vehicle information previously obtained by system 100. Interface 250 may further include geographical results portion 207 that displays visual representation of search results overlaid on a map, allowing a user to locate available vehicles. Geographical results portion 207 may be generated when the vehicle information obtained by system 100 includes location data associated with the vehicle or the dealer of the vehicle.

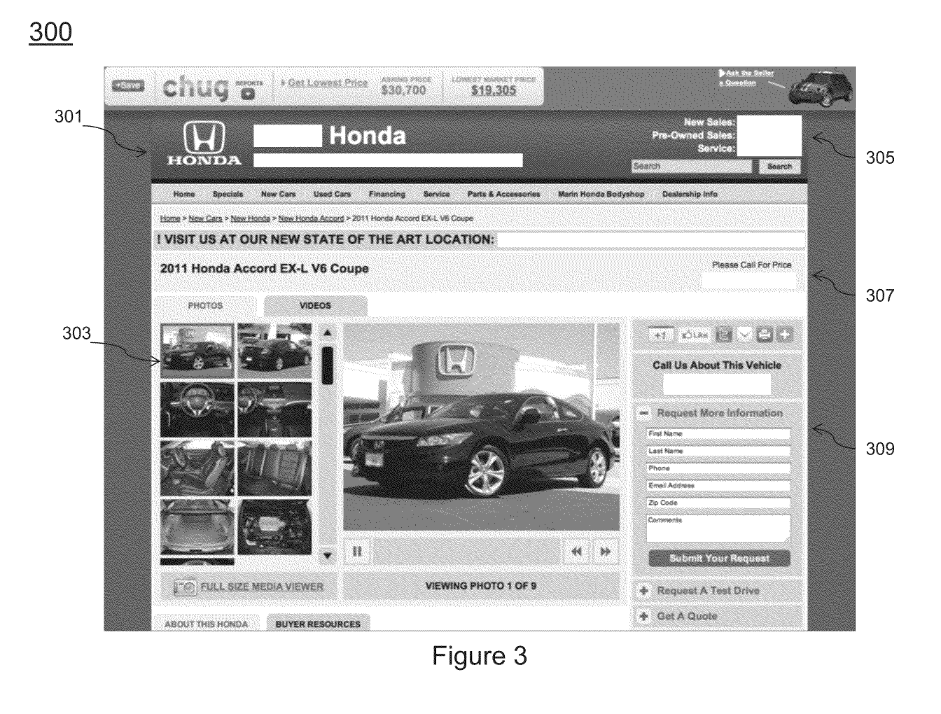

FIG. 3 illustrates an exemplary interface 300 of a dealer's website that may be presented to a user in response to a selection of a vehicle listed within results portion 203 of interface 250. Interface 300 may include a page 301 containing more detailed information about the vehicle selected in results portion 203. In some examples, the page 301 may be a page from a website of the dealer of the vehicle selected in results portion 203 of interface 250. The dealer's website may be separate from the search website (e.g., may have separate domain names). In other words, a deep link (e.g., a URL) may be provided in results portion 203 to link the user to a particular page on the dealer's website. For example, if a user selected a Honda vehicle within results portion 203, system 100 may deep link (e.g., by providing a deep link URL or otherwise directing the user to the webpage) the user to a specific page of the Honda dealer's website, thereby causing a display of interface 300 containing a page 301 from the Honda dealer's website. The page on the Honda dealer's website may be a page specifically generated for the selected vehicle. For instance, the page may include information specific to the selected vehicle, such as brand, model, year, color, mileage, price, VIN, location, or the like.

In some examples, the system 100 may track the number of users that are deep linked to pages on various websites, allowing system 100 to charge the webpage owner a fee for each directed user. Alternatively, tracking may be performed by the dealer website and reported to the owner of system 100. By connecting the user to the dealer directly, the dealer is allowed to present information about the vehicle in a desired manner. For example, the dealer may format page 301 to include various images 303, videos, and descriptions of the vehicle. Page 301 may further include contact information 305 and 307 of the dealer to allow the user to contact the dealer to obtain additional information. A request form 309 may also be included to allow the user to directly contact the dealer.

By connecting users to dealers directly using system 100, an improvement over conventional lead generation systems may be obtained. For example, system 100 has been observed to result in a 30-70% sales completion rate. This is substantially larger than the 1-2% experienced by typical lead generation systems.

In some examples, system 100 may be used to support partner websites or search engines. For example, a user may visit the website of a search engine and type the make, model, and color of a desired car. The search query may be sent to system 100 and processed as described above. System 100 may then return a ranked list of vehicles along with associated deep links to the search engine. The search engine may then display the results to the user in a format similar to or different than those shown in FIG. 2B. When a user clicks a deep link, the owner of system 100 may receive a fee from the dealer and may share a portion of the fee with the partnered search engine.

In other examples, the back-end of system 100 may be used to support partner entities or websites by providing a database similar or identical to data storage 111 to the partner entity or website. In these examples, a user may visit the partner entity or website (e.g., an automobile search website) and type the make, model, and/or color of a desired car. The partner entity or website may then search the provided database to identify matching vehicles. In some examples, the database may include deep links (e.g., a URL) for each vehicle and the partner entity or website may deep link the user to the appropriate dealer website by providing the deep link URL to the user or by otherwise directing the user to the website using the deep link for a selected vehicle. In other examples, a server of the partner entity or website may direct a user to the back-end of system 100 along with a unique identification of a vehicle selected by the user. The back-end of system 100 may then deep link the user to the appropriate dealer website based on the provided unique identification.

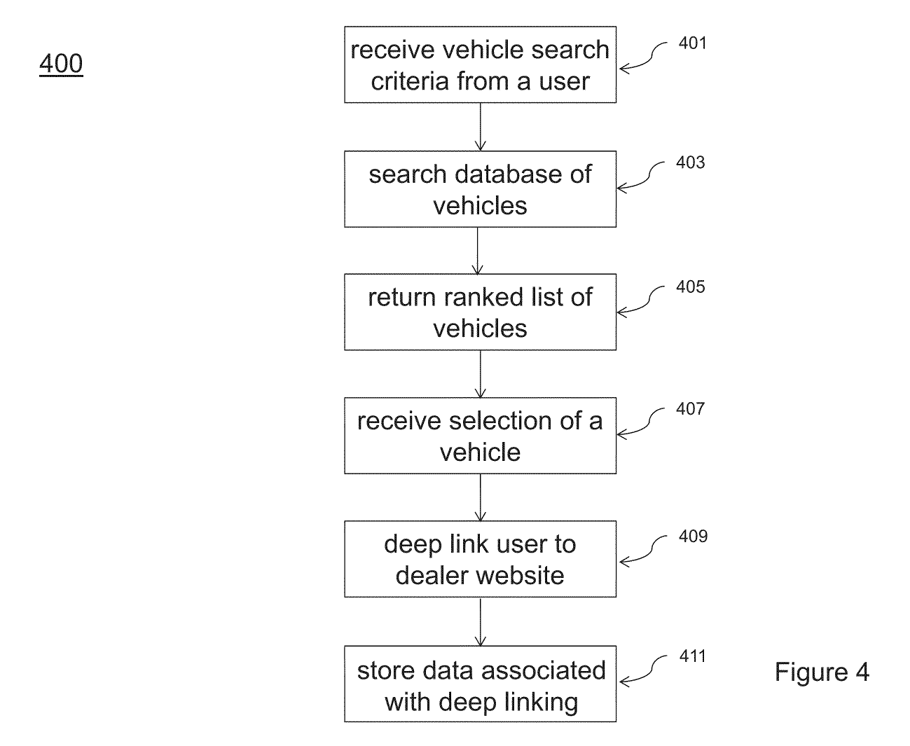

FIG. 4 illustrates an exemplary process 400 that may be used to facilitate introductions between users and dealers. Process 400 may be performed by a system similar or identical to system 100, described above. In some examples, process 400 may be performed by a single entity (e.g., controlling both front and back-ends of system 100) or by multiple entities (e.g., an entity controlling the back-end of system 100 and a search website controlling the front-end of system 100).

At block 401, vehicle search criteria may be received from a user. The search criteria may include any type of vehicle search criteria, such as vehicle brand, model, year, color, VIN, location, or the like. In some examples, the search criteria may be received by the front-end of a system similar or identical to system 100. As mentioned above, in some examples, the front-end of system 100 may be owned or operated by the same entity that owns or operates the back-end of system 100. In these examples, the request may be received from a user via an interface similar or identical to interface 200 of FIG. 2A. Alternatively, in other examples, the front-end of system 100 may be owned or operated by a partner entity or website. In these examples, the request may be received from a user by the partner entity or website via an interface associated with the partner entity or website.

At block 403, a database of vehicles may be searched using the received search criteria. In some examples, a system similar or identical to system 100 may use a search index 113 to search and rank vehicles stored in a database similar or identical to data storage 103 or 111. As mentioned above, in some examples, the front-end of system 100 may be owned or operated by the same entity that owns or operates the back-end of system 100. In these examples, the owner of system 100 may search and rank the vehicles using search index 113. Alternatively, in other examples, the front-end of system 100 may be owned or operated by a partner entity or website. In these examples, a database similar or identical to data storage 111 may be provided to the partner entity or website, and that partner entity or website may search the database using the search criteria received at block 401. In either case, the vehicle databases may be generated by crawling/parsing dealer websites using a crawler/parser similar or identical to crawler/parser 101. The vehicle databases may also receive vehicle data from partnered data aggregators 105.

At block 405, the results of the search may be returned to the user. In some examples, the front-end of a system similar or identical to system 100 may be used to provide an interface for displaying the search results to a user. The interface may include a ranked list of vehicles matching the user's search criteria. The interface may further display refining search options to allow the user to modify the initial search to narrow down the search results. In some examples, historical pricing data and geographical location mapping may also be provided to the user via the results interface. As mentioned above, in some examples, the front-end of system 100 may be owned or operated by the same entity that owns or operates the back-end of system 100. In these examples, the results of the search may be provided to the user via an interface similar or identical to interface 250 of FIG. 2B. Alternatively, in other examples, the front-end of system 100 may be owned or operated by a partner entity or website. In these examples, the results of the search may be provided to the user via an interface associated with the partner entity or website.

At block 407, a selection of a vehicle may be received. In some examples, the front-end of a system similar or identical to system 100 may receive a selection of a particular vehicle provided to the user at block 405. As mentioned above, in some examples, the front-end of system 100 may be owned or operated by the same entity that owns or operates the back-end of system 100. In these examples, the selection of a vehicle displayed within the results interface provided at block 405 may be received in response to a user selection made using any conventional means, such as a click of an image or associated text displayed within results portion 203 of interface 250. Alternatively, in other examples, the front-end of system 100 may be owned or operated by a partner entity or website. In these examples, the selection may be received by the partner entity or website via the interface provided to the user at block 405.

In response to receiving the selection of a particular vehicle at block 407, the user may be deep linked to a dealer website (e.g., as shown in FIG. 4) at block 409. The dealer website may be separate from the website used to receive the vehicle search criteria at block 401 and to provide the ranked list of vehicles at block 405. The deep linked page may include vehicle information, such as images, videos, descriptions, and the like, specific to the vehicle, as well as contact information for the dealer. By deep linking the user to the dealer's website, the consumer is provided with relevant information about the vehicle as well as means for contacting the dealer directly. This allows the user to quickly obtain information about the vehicle and contact the dealer directly at his/her leisure. This is also beneficial to the dealer, as the dealer may customize the type and presentation of information presented to the user in a way that will increase the likelihood of a sale. In some examples, blocks 407 and 409 may collectively be performed by providing a deep link URL to the user at block 405 and allowing the user to select the deep link URL when selecting a desired vehicle.

As mentioned above, in some examples, the front-end of system 100 may be owned or operated by the same entity that owns or operates the back-end of system 100. In these examples, system 100 may deep link a user to a dealer website by providing a selectable deep link URL within the interface displayed at block 405 or by deep linking the user to the dealer website in response to a selection of a vehicle within the interface. Alternatively, in other examples, the front-end of system 100 may be owned or operated by a partner entity or website. In these examples, the partner entity or website may receive a selection of one of the vehicles at block 407 and may direct a user to the back-end of system 100 along with a unique identification of the selected vehicle. The back-end of system 100 may then deep link the user to the appropriate dealer website based on the provided unique identification. Alternatively, the vehicle database (e.g., data storage 111) provided to the partner entity or website may include deep links to dealer websites, and the partner entity or website may deep link a user to a dealer website by providing the user with the appropriate deep link URL or otherwise directing the user to the appropriate dealer website using the deep links.

At block 411, data associated with the deep linking performed at block 409 may be stored. For example, system 100 may record the number of times a user is deep linked to a page of a particular dealer's website. In other examples, the dealer website may track the number of times a user is deep linked to a page of their website. The owner of the deep linking system may then charge the dealer a fee for each user directed to the deep linked page.

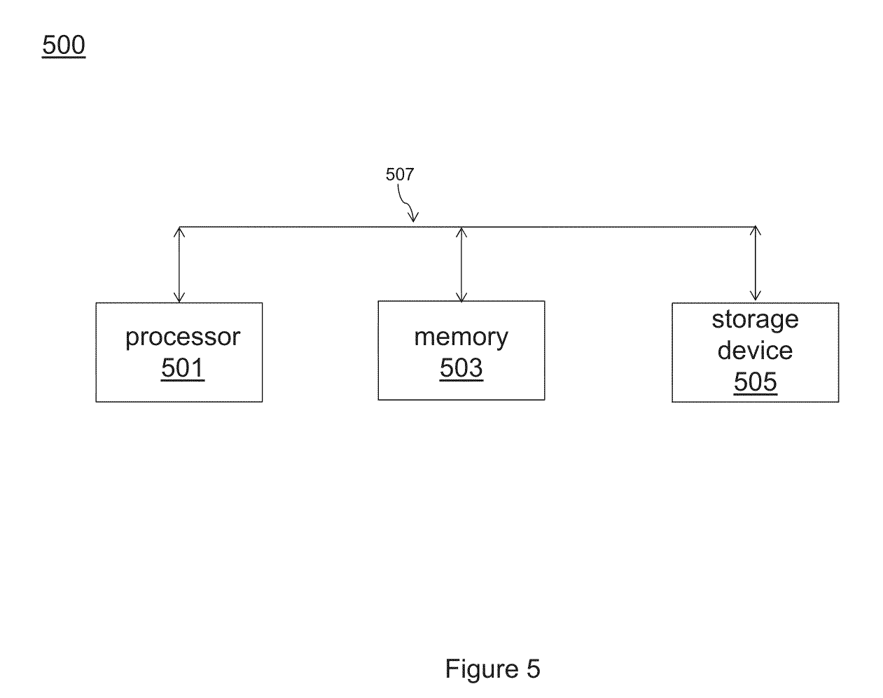

FIG. 5 illustrates an exemplary computing system 500 that may be employed to implement processing functionality for various aspects of the current technology. Components of computing system 500 may be used to implement the steps of exemplary process 400. Those skilled in the relevant art will also recognize how to implement the current technology using other computer systems or architectures. Computing system 500 may represent, for example, a server or a user device such as a desktop, mobile phone, and so on as may be desirable or appropriate for a given application or environment. Computing system 500 can include one or more processors, such as a processor 501. Processor 501 can be implemented using a general or special purpose processing engine such as, for example, a microprocessor, microcontroller or other control logic. In this example, processor 501 is coupled to a bus 507 or other communication medium.

Computing system 500 can also include a memory 503, such as random access memory (RAM) or other dynamic memory, for storing information and instructions to be executed by processor 501. Memory 503 also may be used for storing temporary variables or other intermediate information during execution of instructions to be executed by processor 501. Computing system 500 may likewise include a read only memory (“ROM”) or other static storage device coupled to bus 507 for storing static information and instructions for processor 501.

The computing system 500 may also include storage device 505, which may include, for example, a media drive and a removable storage interface. The media drive may include a drive or other mechanism to support fixed or removable storage media, such as a hard disk drive, a floppy disk drive, a magnetic tape drive, an optical disk drive, a CD or DVD drive (R or RW), or other removable or fixed media drive. Storage media may include, for example, a hard disk, floppy disk, magnetic tape, optical disk, CD or DVD, or other fixed or removable medium that is read by and written to by the media drive. As these examples illustrate, the storage media may include a non-transitory computer-readable storage medium having stored therein particular computer software or data.

In this document, the terms “computer program product” and “non-transitory computer-readable storage medium” may be used generally to refer to media such as, for example, memory 503 or storage device 505. These and other forms of non-transitory computer-readable storage media may be involved in providing one or more sequences of one or more instructions to processor 501 for execution. Such instructions, generally referred to as “computer program code” (which may be grouped in the form of computer programs or other groupings), when executed, enable the computing system 500 to perform features or functions of embodiments of the current technology.

In an embodiment where the elements are implemented using software, the software may be stored in a non-transitory computer-readable storage medium and loaded into computing system 500 using, for example, a removable storage drive, media drive, or communications interface. The control logic (in this example, software instructions or computer program code), when executed by the processor 501, causes the processor 501 to perform the functions of the technology as described herein.

It will be appreciated that, for clarity purposes, the above description has described embodiments of the invention with reference to different functional units and/or modules. However, it will be apparent that any suitable distribution of functionality between different functional units, modules or domains may be used without detracting from the invention. For example, functionality illustrated to be performed by separate modules, processors or controllers may be performed by the same module, processor or controller. Hence, references to specific functional units are only to be seen as references to suitable means for providing the described functionality, rather than indicative of a strict logical or physical structure or organization.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; and adjectives such as “conventional,” “traditional,” “normal,” “standard,” “known”, and terms of similar meaning, should not be construed as limiting the item described to a given time period, or to an item available as of a given time. But instead these terms should be read to encompass conventional, traditional, normal, or standard technologies that may be available, known now, or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to”, or other like phrases in some instances shall not be read to mean that the narrower case is intended or required in instances where such broadening phrases may be absent.

What is claimed is:

1. A method for facilitating introductions between a consumer and a dealer of an automobile, the method comprising:
providing a database comprising information for a plurality of automobiles being sold by a plurality of automobile dealers; and
in response a consumer selecting an automobile of the plurality of automobiles from a search website, deep linking the consumer to a webpage of a dealer's website, wherein the webpage comprises information specific to the selected automobile, and wherein the search website is separate from the dealer's website.

2. The method of claim 1, further comprising, prior to the consumer selecting the automobile:
receiving, from the consumer, automobile search criteria;
searching the database using the search criteria; and
transmitting a ranked list of automobiles based on the searching of the database, wherein the consumer selects the automobile from the ranked list.

3. The method of claim 2, wherein deep linking the consumer to the webpage of the dealer's website comprises transmitting, to the consumer, a deep link URL for the webpage in the ranked list.

4. The method of claim 2, wherein the search criteria comprises one or more of vehicle identification number (VIN), make, model, color, price, or location.

5. The method of claim 1, wherein the method further comprises populating the database using a crawler.

6. The method of claim 1, wherein the method further comprises populating the database using information received from a dealer or a third party entity.

7. The method of claim 1, further comprising:
tracking a number of times that consumers are deep linked to the dealer's website; and
charging a fee to an owner of the dealer's website based on the tracked number of times that consumers are deep linked to the dealer's website.

8. The method of claim 1, wherein the method further comprises receiving, from a server of the search website, a unique identifier for the selected automobile.

9. The method of claim 8, wherein deep linking the consumer to the webpage of the dealer's website comprises transmitting a deep link URL for the webpage to the server of the search website.

10. The method of claim 8, wherein deep linking the consumer to the webpage of the dealer's website comprises transmitting a deep link URL for the webpage to the consumer.

11. A non-transitory computer-readable storage medium comprising computer executable instructions for facilitating introductions between a consumer and a dealer of an automobile, the computer executable instructions for:
providing a database comprising information for a plurality of automobiles being sold by a plurality of automobile dealers; and
in response a consumer selecting an automobile of the plurality of automobiles from a search website, deep linking the consumer to a webpage of a dealer's website, wherein the webpage comprises information specific to the selected automobile, and wherein the search website is separate from the dealer's website.

12. The non-transitory computer-readable storage medium of claim 11, further comprising instructions for:
receiving, from the consumer and prior to the consumer selecting the automobile, automobile search criteria;
searching the database using the search criteria; and
transmitting a ranked list of automobiles based on the searching of the database, wherein the consumer selects the automobile from the ranked list.

13. The non-transitory computer-readable storage medium of claim 12, wherein deep linking the consumer to the webpage of the dealer's website comprises transmitting, to the consumer, a deep link URL for the webpage in the ranked list.

14. The non-transitory computer-readable storage medium of claim 11, further comprising instructions for:
tracking a number of times that consumers are deep linked to the dealer's website; and
charging a fee to an owner of the dealer's website based on the tracked number of times that consumers are deep linked to the dealer's website.

15. The non-transitory computer-readable storage medium of claim 11, further comprising instructions for receiving, from a server of the search website, a unique identifier for the selected automobile.

16. The non-transitory computer-readable storage medium of claim 15, wherein deep linking the consumer to the webpage of the dealer's website comprises transmitting a deep link URL for the webpage to the server of the search website.

17. The non-transitory computer-readable storage medium of claim 15, wherein deep linking the consumer to the webpage of the dealer's website comprises transmitting a deep link URL for the webpage to the consumer.

18. Apparatus for facilitating introductions between a consumer and a dealer of an automobile, the apparatus comprising:
a database comprising information for a plurality of automobiles being sold by a plurality of automobile dealers; and
a processor configured to deep link the consumer to a webpage of a dealer's website in response a consumer selecting an automobile of the plurality of automobiles from a search website, wherein the webpage comprises information specific to the selected automobile, and wherein the search website is separate from the dealer's website.

19. The apparatus of claim 18, wherein the processor is further configured to:
receive, from the consumer and prior to the consumer selecting the automobile, automobile search criteria;
search the database using the search criteria; and
transmit a ranked list of automobiles based on the searching of the database, wherein the consumer selects the automobile from the ranked list.

20. The apparatus of claim 19, wherein deep linking the consumer to the webpage of the dealer's website comprises transmitting, to the consumer, a deep link URL for the webpage in the ranked list.

21. The apparatus of claim 19, wherein the search criteria comprises one or more of vehicle identification number (VIN), make, model, color, price, or location.

22. The apparatus of claim 18, wherein the processor is further configured to populate the database using a crawler.

23. The apparatus of claim 18, wherein the processor is further configured to populate the database using information received from a dealer or a third party entity.

24. The apparatus of claim 18, wherein the processor is further configured to:
track a number of times that consumers are deep linked to the dealer's website; and
charge a fee to an owner of the dealer's website based on the tracked number of times that consumers are deep linked to the dealer's website.

25. The apparatus of claim 18, wherein the processor is further configured to receive, from a server of the search website, a unique identifier for the selected automobile.

26. The apparatus of claim 25, wherein deep linking the consumer to the webpage of the dealer's website comprises transmitting a deep link URL for the webpage to the server of the search website.

27. The apparatus of claim 25, wherein deep linking the consumer to the webpage of the dealer's website comprises transmitting a deep link URL for the webpage to the consumer.
